(19) United States
(12) Patent Application Publication
(10) Pub. No.: US 2011/0036125 A1
(43) Pub. Date: Feb. 17, 2011

(54) BLOCKS FOR RECEIVING A MOLTEN MATERIAL, ESPECIALLY GLASS, AND FIBERIZING INSTALLATION PROVIDED WITH SUCH BLOCKS

(75) Inventors: Olivier Bony, Grenoble (FR); Aurelien Berthelot, Chambery (FR); Alessandro Giassi, Paris (FR); Francois Vianey, Paris (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Saint-Gobain Technical Fabrics Europe, Chambery (FR)

(21) Appl. No.: 12/740,572

(22) PCT Filed: Oct. 21, 2008
(86) PCT No.: PCT/FR2008/051896

§ 371 Date: Oct. 27, 2010

(30) Foreign Application Priority Data
Oct. 29, 2007 (FR) 0758641

(51) Int. Cl. C03B 37/08; C03B 37/00

(52) U.S. Cl. 65/495

(57) ABSTRACT

Flow block (1), intended for a fiberizing installation and for receiving molten material, comprising a single cavity (10) which has a flow channel (11) bounded by a wall (11a). The inlet orifice (12) has a shape which is asymmetrical with respect to the mid-plane (Y) of the block extending along the shortest extension and has an upstream part on the glass inflow side which is wider than its opposite downstream part with respect to the mid-plane. Furthermore, the slope of the wall (11a) on the upstream side is advantageously steeper than the slope of the downstream side. The invention also relates to the bushing block, which is very squat compared with the flow block.

The invention relates to blocks for receiving molten material, such as glass, and in particular to the flow block and the bushing block of a fiberizing installation that delivers filaments, especially glass filaments.

Conventionally, a fiberizing installation comprises, in what is called direct melting, a flow block, which receives the molten glass coming from a channel connected to the furnace in which the glass is melted, a bushing block and a bushing, the bushing block forming the join between the flow block and the bushing. The bushing is provided in its upper part with a screen, which allows the flow of glass coming from the bushing block and feeding said bushing to be distributed, and the glass to be heated by Joule effect, and is provided at the bottom with a plate provided with a plurality of orifices from which the molten glass flows out, to be drawn into a multiplicity of filaments.

These filaments, the diameter of which generally varies from 5 to 33 μm, are collected together into at least one bundle that converges towards an assembling device in order to form at least one strand and, for example, to be wound up. Depending on its use, the strand may also be chopped (to form chopped strands) or thrown onto a belt (to form continuous strand mats).

The products obtained are used mainly in various reinforcing applications.

In a manufacturing plant, a plurality of fiberizing installations are placed alongside one another. Upstream, the molten glass is output by a furnace and flows out through a main channel made of a refractory material in order to be delivered, according to one standard configuration type, into two transverse channels in the manner of a T bar. This T bar is usually called the forehearth, and the plurality of fiberizing installations are placed beneath its bottom.

The difficulty found in such a configuration, and therefore in such a distribution, is the presence of a hot zone at the point where the hottest stream of the glass enters, i.e. at the intersection of the bar of the T, called the upstream portion of the forehearth, and therefore at the two first fiberizing installations placed on each side of this intersection; in contrast, at the ends of the bar of the T, on the two sides downstream of the forehearth, the stream of glass is cooler, the cooling being accentuated by the end wall of the channel of the forehearth.

The temperature of the glass entering each fiberizing installation is therefore different depending on the position of the fiberizing installation beneath the forehearth and depending on the geometric particularity of this forehearth.

Now, this thermal imbalance has an effect on the flow of glass that emanates from the bottom of the bushing of the fiberizing installation, and consequently modifies the linear density of the filaments from one fiberizing installation to another.

Thus, this drawback makes the quality of the strand linear density uncertain, sometimes causing the fiberizing process to be interrupted, and consequently time is wasted and material lost. This is manifested by a reduction in the quality of the products manufactured and an increase in the amount of scrap and therefore an increase in the production cost.

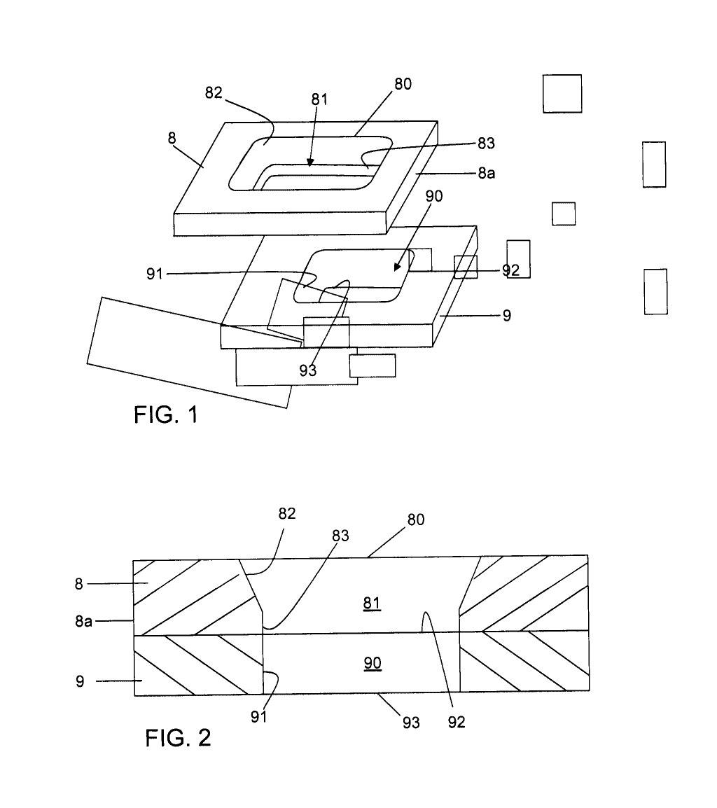

In general, the flow block and the bushing block have the internal geometry illustrated in FIG. 1 (drawn in perspective) and FIG. 2 (drawn in cross section). The flow block 8 has a rectangular opening 80 with four rounded corners, a channel 81, the wall 82 of which, connected to the opening, has a slope which is identical over the entire periphery and is inclined at an acute angle relative to the vertical defined by the external wall 8a of the block. The wall 82 is extended by a vertical wall 83 parallel to the external wall 8a and the perimeter of which reproduces the rectangular geometric shape with rounded corners of the opening 80. The bushing block 9 has a channel 90 that extends the channel 81 and the wall 91 of which is vertical, like the wall 83, and the opening opposed ends 92 and 93 of which are also bounded by a rectangular shape with rounded corners.

It has been noticed that the thermal imbalance in the bushing may be corrected, to ensure a uniform temperature, by adapting, in particular by construction, the size and the geometry of the forehearth and/or of the flow block and/or of the bushing block.

Document U.S. Pat. No. 6,044,666 discloses for example one particular arrangement of the inside of the flow block. Instead of having a single cavity over the entire length of the flow block and of the bushing block through which the molten material flows, that document discloses the presence of walls forming, in the place of the cavity, a plurality of inlet orifices and of channels of different width, thus making it possible to deflect the main glass flow in order for it to be better mixed when it arrives in the bushing.

Another solution for making the molten glass in the fiberizing installation follow a defined path, so as to ensure better mixing in terms of temperature uniformity, is to adapt the configuration of the bushing. U.S. Pat. No. 5,928,402 discloses in particular such a solution. The bushing is designed in a particular way that includes two spaced-apart screens placed above the bottom of the bushing, the screens being partly closed off at different points depending on the way they are arranged opposite each other.

However, the chosen aspect of the invention more particularly relates to the adaptation of the shape of the flow block and that of the bushing block.

The object of the invention is therefore to provide these blocks with a particular geometry so as to increase the thermal uniformity of the glass entering the bushing, so as to improve in the end the thermal uniformity of the glass exiting the bushing and therefore its viscosity, and to do so independently of the shape of the bushing.

According to the invention, the flow block, intended for a fiberizing installation and for receiving molten material, comprises a single cavity which has a flow channel bounded by a wall, an inlet orifice and an outlet orifice which are located at the two opposed ends of the channel respectively, the inlet orifice being located on a face called the upper face, which has two opposed lateral edges and two opposed longitudinal edges, and which has a longitudinal mid-plane (P) extending along the largest extension of the face and another mid-plane (Y) extending along the shortest extension of the face. The flow block is characterized in that the inlet orifice has a shape which is asymmetrical with respect to the mid-plane (Y) of the block extending along the shortest extension.

Although in the prior art the inlet orifice, generally of rectangular shape, is completely symmetrical, the invention makes it possible, thanks to the asymmetry, to distribute the inflow of glass into the cavity of the flow block in another way so as to ensure better temperature uniformity at the exit.

According to one feature, the inlet orifice has an upstream part intended to be placed on the molten material inflow side and a downstream part opposite the upstream part with respect to the mid-plane (Y) extending along the shortest extension, the upstream part being wider than the downstream part.

Throughout the rest of the description, the terms ‘upstream’ and ‘downstream’ are understood to be qualifiers that correspond to the upstream-to-downstream flow direction of the molten material through the forehearth of the fiberizing installation.

The terms ‘upper’ and ‘lower’ in the rest of the description should be understood to be the highest and lowest parts, respectively, of an element facing a part of the fiberizing installation which, positioned for its operation, receives the flow of the material to be fiberized from the top down.

According to another feature, the inlet orifice has a profile along a closed line having two points that correspond to the two points placed closest, respectively, to the two longitudinal edges of the upper face of the block, the distance between these points being at least equal to 0.3×L1, where L1 is the dimension separating the two longitudinal edges, and preferably greater than 0.5×L1.

Advantageously, the cavity of the block converges towards the outlet orifice.

In particular, the ratio of the area of the outlet orifice to the area of the inlet orifice is less than 0.5.

The pronounced narrowing of the outlet orifice compared with the inlet orifice, combined with the asymmetry, further improves the more uniform distribution of the temperatures of the molten material within the cavity of the flow block.

According to another feature, the inlet orifice has a profile along a closed line having at least six portions which are curved or linear, joining six points respectively.

The six points are joined by six imaginary segments respectively, two of which, called the upstream lateral sides, are intended to be placed on the molten material inflow side, two of which, called the downstream lateral sides, are located opposite the upstream sides with respect to the mid-plane (Y) extending along the shortest extension, and two of which, called intermediate sides, each join an upstream lateral side and a downstream lateral side respectively.

Advantageously, the upstream lateral sides make an angle α with the longitudinal mid-plane (P) of between 45° and 90°.

The downstream lateral sides make an angle β with the longitudinal mid-plane (P) of between 0° and 60°.

The intermediate sides at the points of intersection with the upstream lateral sides make an angle γ with the longitudinal mid-plane (P) of between 0° and 45°.

In addition, the intermediate sides starting from the upstream lateral sides converge preferably towards the longitudinal plane (P).

Advantageously, the inlet orifice has a profiled line which is curved over its entire perimeter so that the wall of the cavity has a curved shape over the entire periphery without any discontinuity, permitting the material to flow better.

Preferably, the wall of the flow channel of the flow block has a slope from the inlet orifice that is not uniform over the entire periphery of the wall. The wall has at least two different slopes. In particular it has, on the upstream side of the inlet orifice, a steeper slope than the slope located on the side of the downstream part of the orifice, opposite the upstream part.

The invention also relates to the flow block described above, associated with a bushing block, the two blocks being intended for a fiberizing installation, the bushing block having a single cavity that has an inlet opening, adjoining the outlet orifice of the flow block, a wall and an outlet opening.

According to one feature of the invention, the ratio of the height of the bushing block to the height of the flow block is less than 0.6 and preferably less than 0.45.

In addition, the cavity of the bushing block has a shape flared towards the outlet opening. If the flow block is in the form of a funnel with an asymmetric cross section, the bushing block has the form of an upside-down and very squat funnel, of asymmetric cross section.

Finally, the invention relates to a fiberizing installation comprising a flow block and a bushing block as described above, together with a bushing provided with an inlet which abuts the outlet opening of the bushing block and is intended to receive the molten material. In particular, the outlet opening of the bushing block has a cross section that coincides with the cross section of the inlet of the bushing.

As is known, the bushing has an axis of symmetry (X). Although in the prior art the inlet orifice of the flow block is completely symmetrical and has an axis of symmetry that corresponds to that of the bushing, on the contrary, in the invention, the mid-point of an imaginary segment separating two points which are furthest apart of the closed line profile of the inlet orifice of the flow block is off-centered with respect to the axis of symmetry (X) of the bushing. This configuration also helps the temperature uniformity of the material flowing into the bushing.

Other advantages and features of the invention will now be described in greater detail in conjunction with the appended drawings in which:

FIG. 1 is an exploded perspective view of a flow block and a bushing block of the prior art intended for a fiberizing installation;

FIG. 2 is a sectional view of the elements of FIG. 1;

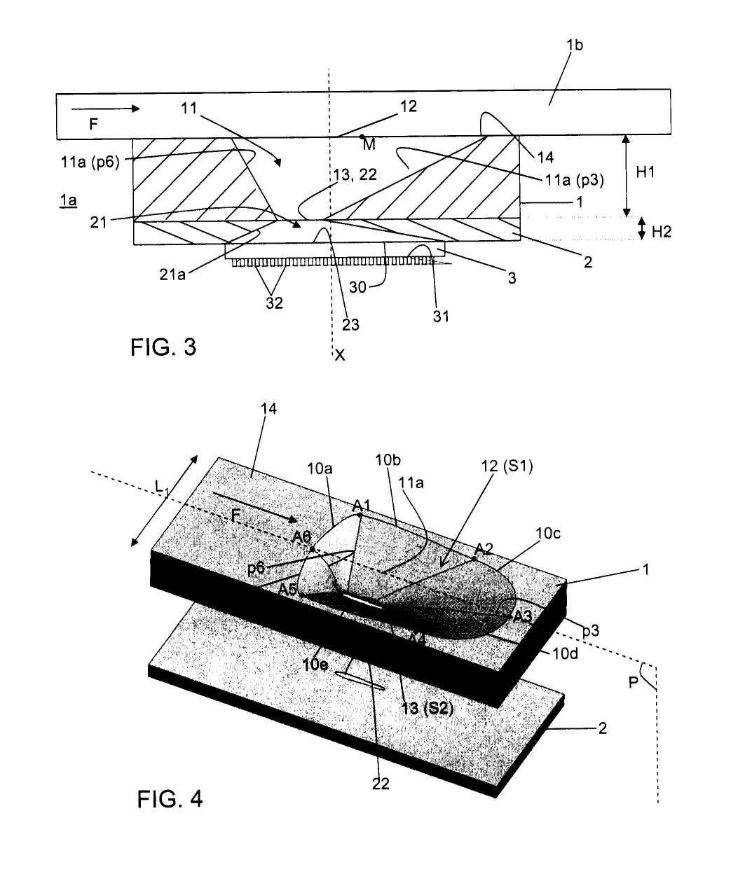

FIG. 3 is a sectional view of part of a fiberizing installation comprising the flow block and the bushing block according to one embodiment of the invention, and also a usual bushing;

FIG. 4 is an exploded perspective view of the flow block and the bushing block of FIG. 3;

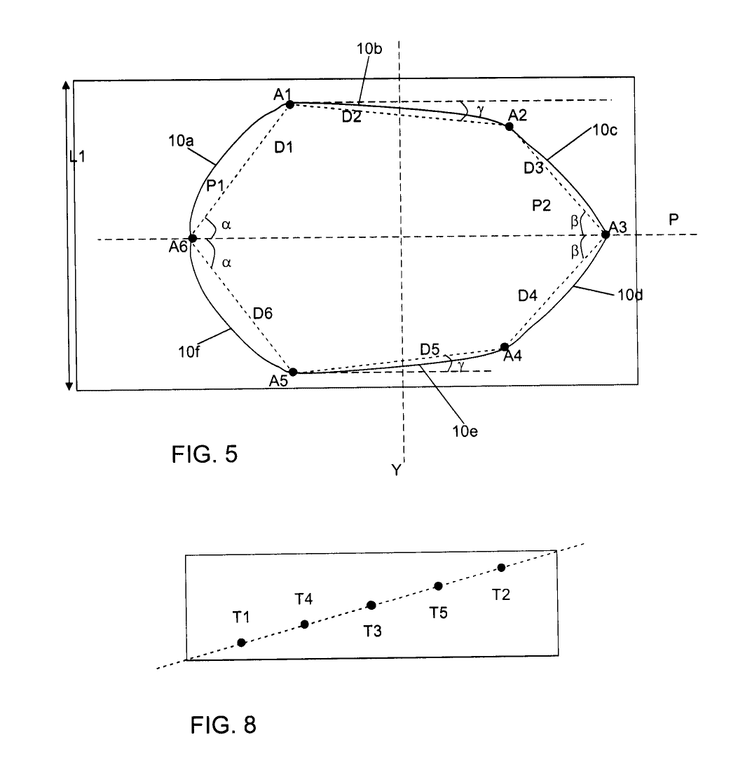

FIG. 5 is a top view of the flow block of FIG. 4;

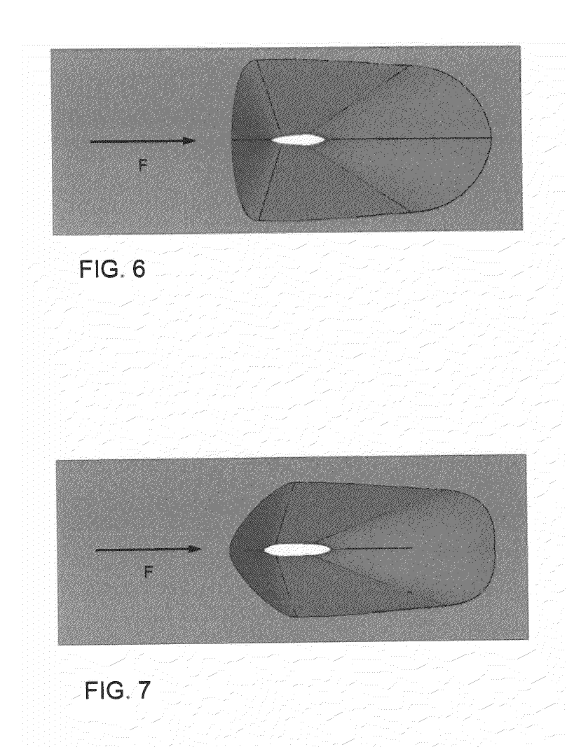

FIGS. 6 and 7 are top views of the flow block according to two other embodiments of the invention; and

FIG. 8 illustrates a top view of a bushing screen indicating the temperature measurement points.

FIG. 3 illustrates schematically part of a fiberizing installation 1a. The forehearth 1b receives molten material such as glass which flows along the direction of the arrow F, from upstream to downstream. In the part below the forehearth, the installation comprises a flow block 1 according to the invention, which receives the molten material from the forehearth channel, a bushing block 2 according to the invention, through which the molten material from the flow block 1 flows, and a usual bushing 3 into which the glass enters.

The invention may of course be applied to any type of molten material capable of being fiberized, including thermoplastic material.

The bushing 3 has, in a known manner and with the glass entering from the top downwards, a screen 30 on its upper face and a bottom 31 on its opposite face. The screen 30 is provided with openings (not illustrated) and slows down the flow of glass delivered into the bushing. The screen also heats the glass by Joule effect. The bottom 31 is provided with a plurality of drilled orifices or tips 32 that extend over practically the entire surface of the bottom in order to deliver glass filaments to the outside of the bushing.

FIG. 4 shows an exploded perspective view of the flow block 1 and the bushing block 2 according to the invention.

These blocks are made of refractory materials that withstand the thermal degradation, corrosion and erosion due to the flow of the molten material.

In general, a ceramic material is used which may for example be, as is known, alumina, silicon nitride or zirconia, or else may be an ODS (Oxide Dispersion Strengthened) alloy based on nickel or iron or titanium, or else a refractory alloy based in particular on tungsten or molybdenum or niobium.

The blocks 1 and 2, which are adjoining, each have a single cavity 10 and 20 respectively, through which the glass flows. The solution of producing the blocks with a single cavity results in less wear than a plurality of channels, as disclosed in the aforementioned prior art U.S. Pat. No. 6,044,666.

To make manufacture easier, the blocks are preferably symmetrical with respect to the mid-plane P, which is vertical along the flow direction of the glass from the top down and which lies parallel to the largest extension of the blocks.

The invention relates only to the shape of the cavities 10 and 20 of the blocks, the external shape and the overall dimensions of the two blocks are those of the prior art. The blocks are of parallelepipedal external shape, their outside dimensions generally being around 0.3 to 2.5 m in length and 0.1 to 1 m in width.

The cavity 10 of the flow block 1 has a flow channel 11 bounded by a wall 11a, an inlet orifice 12 located at the upper face 14 of the block, coplanar with the bottom of the channel of the forehearth 1b into which the glass enters, and an outlet orifice 13 in the lower part, which is located at the opposite end from the inlet orifice 12, at the junction with the cavity 20 of the bushing block.

The cavity 20 of the bushing block 2 has a flow channel 21 bounded by a wall 21a, an inlet opening 22 which abuts the outlet orifice 13 of the flow block, and an outlet opening 23 located at the junction with the bushing 3, opening onto the screen 30.

As mentioned above, the upper face 14 of the flow block is located, in the position of the block mounted in the fiberizing installation, in the plane of the bottom of the channel of the forehearth 1b. The face 14 has, along its shortest extension, two lateral edges that are opposed with respect to a mid-plane Y extending along the shortest extension of the block and two longitudinal edges that are opposed with respect to the longitudinal mid-plane P.

The face 14 here has a rectangular shape. The lateral edges have a width L1.

According to the invention, and as can be seen in FIGS. 3 to 5, the shape of the cavity 10 can be likened to a funnel, the entry cross section 12 of which is asymmetrical, having a wider upstream part P1 than its downstream part P2, and the slope p6 of the wall 11a of which, on the upstream side, is steeper than the slope p3 on the downstream side.

The cavity and therefore the inlet orifice 12 have an asymmetrical shape with respect to the mid-plane Y extending along the shortest extension of the block.

The inlet orifice 12 has an upstream part P1 placed on the molten material inflow side and a downstream part P2 opposite the upstream part P1 with respect to the mid-plane Y. The upstream part P1 is wider than the downstream part P2.

The inlet orifice 12 has a profile along a closed line consisting of linear or curved portions. Preferably, the profile is curved over the entire perimeter so as to provide the cavity with a wall having a curved shape over the entire periphery without any discontinuity.

In the preferred embodiment of the invention, the profile has at least six portions 10a, 10b, 10c, 10d, 10e, 10f which join six points A1, A2, A3, A4, A5, A6 respectively.

The shape of the inlet orifice is better explained by choosing to consider the six imaginary segments D1, D2, D3, D4, D5, D6 (shown by the narrow dotted lines in FIG. 5) which join the six points A1, A2, A3, A4, A5, A6. The segments D1 and D6 are called the upstream lateral sides since they are located closest to the upstream side of the orifice. The segments D3 and D4 are called the downstream lateral sides since they are located opposite the upstream sides with respect to the mid-plane Y. The segments D2 and D5 each join the upstream lateral side D1 and the downstream lateral side D3, and the upstream lateral side D6 and the downstream lateral side D4, respectively.

The upstream lateral sides D1 and D6, which here are symmetrical with respect to the longitudinal mid-plane P, make an angle α with said plane P of between 45° and 90°.

The downstream lateral sides D3 and D4, which here are symmetrical with respect to the longitudinal mid-plane P, make an angle β with said plane P of between 0° and 60°.

The intermediate sides D2 and D5, which here are symmetrical with respect to the longitudinal mid-plane P, starting from the upstream lateral sides D1 and D6, respectively converge towards the longitudinal plane P, thus ensuring that the downstream part P2 is smaller than the upstream part P1.

More particularly, the intermediate sides D2 and D5 at the points of intersection, A1 and A5 respectively, with the upstream lateral sides, D1 and D6 respectively, make an angle γ with the longitudinal mid-plane P of between 0° and 45°.

Moreover, the inlet orifice 12 is particularly large compared with the width of the flow block and therefore with the width of the forehearth channel, at the upstream part P1, so that the two points A1 and A5, which correspond to the two points placed closest, respectively, to the two longitudinal edges of the upper face 14, are separated by a length of at least equal to 0.3×L1, where L1 is the dimension separating the two longitudinal edges, and preferably greater than 0.5×L1.

Again according to the invention, the cavity 10 converges towards the outlet orifice 13, the area S2 of the outlet orifice 13 being smaller than the area S1 of the inlet orifice 12. The narrowing is sufficiently great and is such that the ratio of the areas S2/S1 is less than 0.5.

Finally, the wall 11a of the flow channel 11 of the flow block has a slope which, starting from the line of the inlet orifice 12, is not uniform over the entire periphery of the wall.

Preferably, the slope of the wall changes at each of the six points A1, A2, A3, A4, A5 and A6. Because of the symmetry of the cavity with respect to the plane P, there are only four distinct slopes at the points A6, A1, A2 and A3 (FIG. 4). According to the invention, the slope p6 at the furthermost upstream end of the cavity, i.e. at the point A6, is steeper than the slope p3 at the furthermost downstream end of the cavity, i.e. at the point A3.

The bushing block 2 itself has a shape flared towards the outlet opening 23, the cross section of the inlet opening 22 corresponding to the narrowed cross section of the outlet orifice 13 of the flow block, whereas the cross section of the outlet opening 23 corresponds to the area of the bushing screen 30.

According to the invention, this sudden widening of the cross section between the inlet opening 22 and the outlet opening 23 takes place over a very short height since the bushing block 2 has, along the vertical, a much smaller height than that of the flow block. Taking H1 as the height of the flow block 1 and H2 as the height of the bushing block, the ratio H2/H1 is less than 0.6 and preferably less than 0.45.

Thus, the asymmetry of the inlet orifice of the cavity and all of the other particular features mentioned above as regards the flow block and the bushing block ensure optimum temperature uniformity of the glass over the entire area of the bushing screen 30.

As additional examples, FIGS. 6 and 7 illustrate other profiles of the flow block opening 12, showing, according to the invention, the asymmetry of the opening accompanied by a low ratio of the areas S2 and S1 and a downstream shift of the mid-point of the imaginary segment that separates the two points furthest apart of the closed line profile of the flow block inlet orifice with respect to the axis of symmetry (X) of the bushing.

The thermal uniformity was measured by taking a few temperature measurements at identical points on the bushing screen for a reference fiberizing installation with flow and bushing blocks according to the prior art, as described in FIGS. 1 and 2, and for exemplary embodiments of the blocks according to the invention. The screen has for example a rectangular surface.

The points chosen are distributed along one diagonal of the bushing along its largest extension. Two points T1 and T2 are located close to the longitudinal edges of the bushing, a point T3 corresponds to the centre of the bushing, and two other points T4 and T5 are located on either side of the point T3, at mid-distance between the centre of the bushing and a corner of the bushing.

Given below is a table indicating the temperatures at these five points T1 to T5 and the maximum deviation recorded between these points, according to the shape of the blocks, i.e. according to the reference shape (usual fiberizing installation) and according to the shape of the example shown in FIG. 4.

| | | | | | | Maximum |
|---|---|---|---|---|---|---|
| | T1 | | T3 | | | deviation |
| Shape | (° C.) | T2 (° C.) | (° C.) | T4 (° C.) | T5 (° C.) | (° C.) |
| Reference | 1245 | 1247 | 1260 | 1257 | 1257 | 15 |
| Example | 1254 | 1256 | 1263 | 1261 | 1264 | 10 |
| of FIG. 4 | | | | | | |

This table shows that the temperature gradients between the points and the maximum deviation are much larger in the case of the reference bushing than for the bushing associated with the flow block and bushing block shapes of the invention.

The novel geometry of the invention thus improves the temperature uniformity over the entire entry surface of the bushing.

1. A flow block, comprising:
a flow block height;
an upper face;
a lower face;
a longitudinal length, being of greater length;
a lateral width, being of lesser length;
a single cavity comprising a flow channel bounded by a wall;
an inlet orifice, on the upper face, and an outlet orifice, on the lower face, at two opposed ends of the flow channel, respectively,
wherein the upper face comprises a first lateral edge and a second lateral edge, a first longitudinal edge and a second longitudinal edge, a longitudinal mid-plane extending along the longitudinal length, bisecting the first and the second longitudinal edge, and a lateral mid-plane, perpendicular to the longitudinal length and bisecting the diameter of the inlet orifice along the longitudinal length, wherein the inlet orifice has an asymmetrical shape with respect to the lateral mid-plane and in that the inlet orifice comprises an upstream part and a downstream part opposite the upstream part with respect to the lateral mid-plane, the upstream part being wider than the downstream part.

2. The flow block according to claim 1, wherein the inlet orifice has a profile along a closed line comprising a first point and a second point that correspond to the two points placed closest, respectively, to the first longitudinal edge and the second longitudinal edge of the upper face, the first longitudinal edge and the second longitudinal edge being separated by a displacement intersecting the first and the second point, wherein the distance between the first point and the second point is at least equal to 0.3× the displacement.

3. The flow block according to claim 1, wherein the single cavity converges towards the outlet orifice.

4. The flow block according to claim 1, wherein the ratio of the area of the outlet orifice to the area of the inlet orifice is less than 0.5.

5. The flow block according to claim 1, wherein the inlet orifice has a profile comprising at least a first portion, a second portion, a third portion, a fourth portion, a fifth portion, and a sixth portion, which are curved or linear, connecting a front left point, a back left point, a back center point, a back right point, a front right point, and a front center point.

6. The flow block according to claim 5, wherein the front left point, the back left point, the back center point, the back right point, the front right point, and the front center point, connect as:
an upstream right side, between the front center point and the front right point;
an upstream left side, between the front center point and the front left point;
a downstream, right side, between the back right point and the back center point;
a downstream left side, between the back left point and the back center point,
wherein the downstream right side and the downstream right side are located opposite the upstream right side and the upstream left side with respect to the lateral mid-plane;
an intermediate right side, connecting the upstream right side and the downstream right side; and
an intermediate left side, connecting the upstream left side and the downstream left side.

7. The flow block according to claim 6, wherein the upstream right side and the upstream left side make an angle α with the longitudinal mid-plane of between 45° and 90°.

8. The flow block according to claim 6, wherein the downstream right side and the downstream left side make an angle β with the longitudinal mid-plane of between 0° and 60°.

9. The flow block according to claim 6, wherein the intermediate right side and the upstream right side at the front right point and the intermediate left side and the upstream left side at the front left point make an angle γ with the longitudinal mid-plane of between 0° and 45°.

10. The flow block according to claim 6, wherein the intermediate right side and the intermediate left side, starting from the upstream right side and the upstream left side, converge towards the longitudinal mid-plane.

11. The flow block according to claim 1, wherein the inlet orifice has a profiled line which is curved over its entire perimeter.

12. The flow block according to claim 1, wherein the wall of the flow channel has a slope from the inlet orifice that is not uniform over the entire periphery of the wall.

13. The flow according to claim 12, wherein the wall has at least a first slope and a second slope, which are different.

14. The flow block according to claim 13, wherein the first slope on the upstream part of the wall is steeper than the second slope on the downstream part of the wall.

15. The flow block according to claim 1, comprising a bushing block abutting the flow block, wherein the bushing block comprises:
a bushing block height;
a single bushing block cavity;
a bushing block inlet opening, adjoining the outlet orifice of the flow block;
a bushing block wall; and
a bushing block outlet opening.

16. The flow block and the bushing block according to claim 15, wherein the ratio of the bushing block height to the flow block height is less than 0.6.

17. The flow block and the bushing block according to claim 15, wherein the single bushing block cavity has a shape flared towards the bushing block outlet opening.

18. A fiberizing installation comprising the flow block and the bushing block according to claim 15, comprising:
a bushing; and
a bushing inlet abutting the bushing block outlet opening.

19. The fiberizing installation according to claim 18, wherein the bushing comprises an orthogonal axis of symmetry, wherein the mid-point of an imaginary segment separating the front center point and the back center point of the inlet orifice of the flow block is off-centered with respect to the orthogonal axis of symmetry of the bushing.

20. The flow block according to claim 2, wherein the distance between the first point and the second point being at least equal to 0.5× the displacement.
